(19) United States
(12) Patent Application Publication
(10) Pub. No.: US 2025/0383705 A1
(43) Pub. Date: Dec. 18, 2025

(54) CONTROL SYSTEM, CONTROL METHOD, AND RECORDING MEDIUM

(71) Applicant: NEC Corporation, Minato-ku, Tokyo (JP)

(72) Inventors: Yuki TSURUOKA, Tokyo (JP); Akihiko ONITA, Tokyo (JP); Takashi MIYAKE, Tokyo (JP); Yushi NIWA, Tokyo (JP)

(73) Assignee: NEC Corporation, Minato-ku, Tokyo (JP)

(21) Appl. No.: 19/107,639

(22) PCT Filed: Nov. 14, 2022
(86) PCT No.: PCT/JP2022/042168

§ 371 Date: Feb. 28, 2025

(51) Int. Cl. G06F 3/01; G06T 3/40

(52) U.S. Cl. CPC G06F 3/012; G06T 3/40; G06F 3/013

(57) ABSTRACT

A control system comprising: a memory storing instructions; and at least one processor configured to execute the instructions to: detect a face of a person using a sensor; perform control in such a way that when a screen other than a specific screen among a plurality of screens to be displayed on a non-contact display is displayed, an aerial image formation of the non-contact display includes a predetermined height, a predetermined position, a predetermined orientation, and a predetermined size; and perform control to change at least any one of a height, a position, an orientation, and a size of the aerial image formation for displaying the specific screen based on a position of the detected face of the person when the specific screen is displayed.

### TECHNICAL FIELD

The present disclosure relates to a control system and the like.

### BACKGROUND ART

Non-contact displays are known. For example, PTLs 1, 2, and 3 describe that a video is formed in the air using a non-contact display.

In the non-contact display, there is a case where the aerial image formation is displayed in such a way that the user can easily see. For example, PTL 1 describes that an aerial video is displayed in a range perceptible by an observer based on a viewpoint position of the observer. For example, PTL 2 describes that an aerial display device is installed in a kitchen, and a display position of an image on a display included in the aerial display device is adjusted according to a height of a user. PTL 2 describes that a control mechanism such as a motor is provided in a housing in such a way that positions or angles of a display and an optical element included in an aerial display device can be finely adjusted.

In a retail store such as a convenience store, a non-contact display may be used to register a product or settle a product. For example, PTL 3 describes that a non-contact display is used for a self-point of sales (POS).

### CITATION LIST

### Patent Literature

PTL 1: WO 2020/194699 A1
PTL 2: WO 2017/125984 A1
PTL 3: WO 2019/167614 A1

### SUMMARY OF INVENTION

### Technical Problem

For example, in a case where a non-contact display is used in each facility such as a retail store or a government office, it is assumed that users change one after another. At this time, the user may not want another person to peep.

An object of the present disclosure is to provide a control system and the like for suppressing peeping.

### Solution to Problem

A control system according to an aspect of the present disclosure includes a detection means for detect a face of a person using a sensor, and a control means for perform control in such a way that aerial image formation of a non-contact display includes a predetermined height, a predetermined position, a predetermined orientation, and a predetermined size when a screen other than a specific screen among a plurality of screens to be displayed on the non-contact display is displayed, in which the control means performs control to change at least any one of the height, the position, the orientation, and the size of the aerial image formation that displays the specific screen based on a position of the detected face of the person when the specific screen is displayed.

A control method according to an aspect of the present disclosure includes detecting a face of a person using a sensor, and performing control in such a way that when a screen other than a specific screen among a plurality of screens to be displayed on a non-contact display is displayed, an aerial image formation of the non-contact display includes a predetermined height, a predetermined position, a predetermined orientation, and a predetermined size, wherein the performing control includes performing control to change at least one of a height, a position, an orientation, and a size of the aerial image formation for displaying the specific screen based on a position of the detected face of the person when the specific screen is displayed.

A program according to an aspect of the present disclosure causes a computer to execute the steps of detecting a face of a person using a sensor, and performing control in such a way that when a screen other than a specific screen among a plurality of screens to be displayed on a non-contact display is displayed, an aerial image formation of the non-contact display includes a predetermined height, a predetermined position, a predetermined orientation, and a predetermined size, wherein the performing control includes performing control to change at least one of a height, a position, an orientation, and a size of the aerial image formation for displaying the specific screen based on a position of the detected face of the person when the specific screen is displayed.

The program may be stored in a non-transitory computer-readable recording medium.

### Advantageous Effects of Invention

According to the present disclosure, it is possible to suppress peeping.

### BRIEF DESCRIPTION OF DRAWINGS

FIG. 1 is a block diagram illustrating a configuration example of a control system according to the first example embodiment.

FIG. 2 is a flowchart illustrating an operation example of the control system according to the first example embodiment.

FIG. 3 is an explanatory diagram illustrating an example in which an aerial display is used as a display device of a POS system.

FIG. 4 is an explanatory diagram simply illustrating the aerial display.

FIG. 5 is an explanatory diagram illustrating an example of connection between a control system and another device.

FIG. 6 is a block diagram illustrating a configuration example of a control system according to the second example embodiment.

FIG. 7 is an explanatory diagram illustrating an example in which a user's face is detected by an imaging device.

FIG. 8 is an explanatory diagram illustrating an example in which the angle between the display included in the aerial display and the optical element included in the aerial display is controlled.

FIG. 9 is an explanatory diagram illustrating an example in which display of a display included in an aerial display is controlled.

FIG. 10 is an explanatory diagram illustrating an example in which the height of a table is controlled.

FIG. 11 is an explanatory diagram illustrating an example in which a user's name and point information are displayed at specific positions.

FIG. 12 is an explanatory diagram illustrating an example in which a face of another person other than the user is detected.

FIG. 13 is an explanatory view illustrating a display position example of the aerial image formation for the position of a face of another person.

FIG. 14 is an explanatory diagram illustrating an example in which the aerial image formation is brought to the lower right in a case where another person is taller than the user and is on the rear left.

FIG. 15 is an explanatory diagram illustrating an example in which a payment screen and an advertisement of a product are included in aerial image formation.

FIG. 16 is an explanatory diagram illustrating an example of a display position of aerial image formation according to a position of a face of another person.

FIG. 17 is an explanatory diagram illustrating an example of displaying a user's name and point information at the lower right in a case where another person is taller than the user and is at the rear left.

FIG. 18 is a flowchart illustrating an operation example of the control system according to the second example embodiment.

FIG. 19 is an explanatory diagram illustrating a hardware configuration example of a computer.

### EXAMPLE EMBODIMENT

Hereinafter, example embodiments of a control system, a control method, a program, and a non-transitory recording medium recording the program according to the present disclosure will be described in detail with reference to the drawings. The present example embodiment does not limit the disclosed technology.

In a case where the non-contact display is used, there are various facilities such as, but not limited to, a retail store, a government office, a hospital, an accommodation facility such a hotel, a station, or an airport as the facilities at which the use scenes in which users change one after another are generated.

### First Example Embodiment

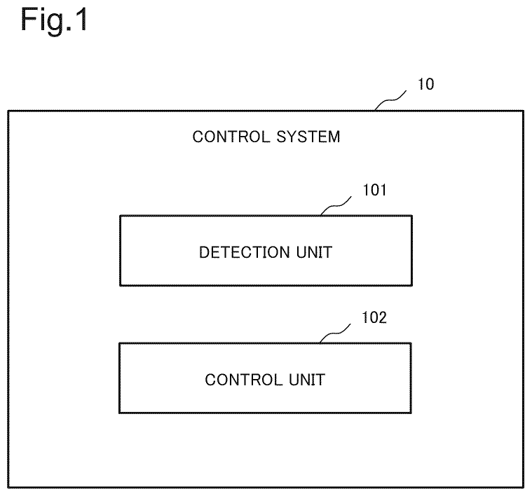

First, in the first example embodiment, a basic function of the control system will be described. FIG. 1 is a block diagram illustrating a configuration example of a control system according to the first example embodiment. The control system 10 includes a detection unit 101 and a control unit 102.

The detection unit 101 detects the face of a person using a sensor. The sensor is not particularly limited, and examples thereof include an imaging device and a human sensor. The person may be a user of the non-contact display, or may be another person other than the user of the non-contact display. The another person is, for example, a person standing behind the user. In the following description, an aerial display will be described as an example of the non-contact display.

The control unit 102 performs control in such a way that an aerial image formation of an aerial display includes a predetermined height, a predetermined position, a predetermined orientation, and a predetermined size when displaying a screen other than a specific screen among a plurality of screens to be displayed by the aerial display. A control method will be described with reference to the second example embodiment. A display mode in which the aerial image formation includes a predetermined height, a predetermined position, a predetermined orientation, and a predetermined size is also referred to as a default mode.

When the specific screen is displayed, the control unit 102 performs control to change at least any one of the height, the position, the orientation, and the size of the aerial image formation for displaying the specific screen based on the position of the detected face of the person. The display mode in which at least any one of the height, the position, the orientation, and the size of the aerial image formation is changed from the default mode is also referred to as an individual mode. However, in a case where the control unit 102 performs control to change at least any one of the height, the position, the orientation, and the size of the aerial image formation for displaying the specific screen based on the position of the detected face of the person, as a result, there is a case where there is no change in any of the height, the position, the orientation, and the size of the aerial image formation from the default mode.

The specific screen may be different depending on a use scene of each facility or the like. For example, the specific screen is a screen including personal information. Alternatively, for example, the specific screen is a screen including a password or the like. The specific screen here may be a screen for outputting personal information and a password, or may be a screen for inputting personal information and a password. The screen other than the specific screen may be, for example, a standby screen or an explanation screen of an operation method.

In a case where the person is a user of the aerial display, the control unit 102 displays a specific screen in such a way that at least any one of the height, the position, the orientation, and the size of the aerial image formation matches the position of the face of the user. For example, since the aerial display has strong display directivity, by changing the display to a display suitable for the user, it is difficult for another person who looks into the aerial display from behind the user to see a specific screen. For example, in a case where the person is a person other than the user of the aerial display, the control unit 102 changes at least any one of the height, the position, the orientation, and the size in such a way that it is difficult to see from the position of the face of another person, and displays a specific screen. Specific control will be described with reference to the second example embodiment.

### Flowchart

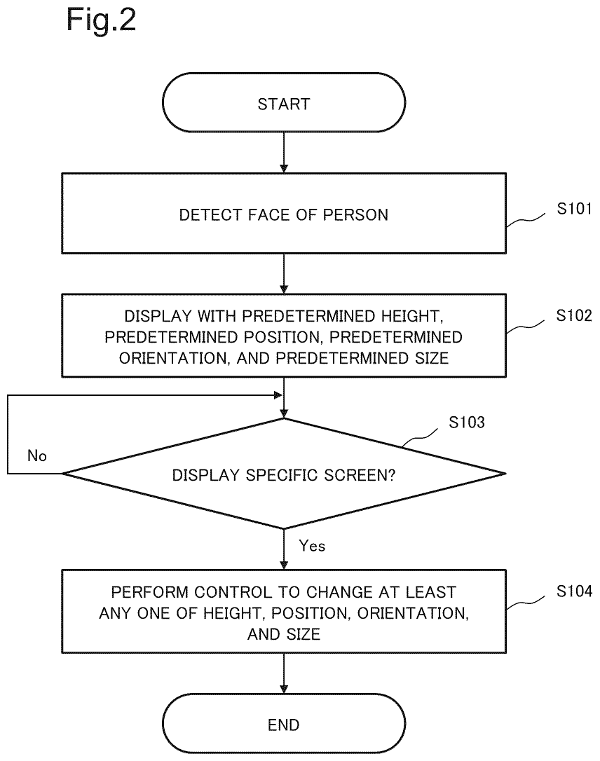

FIG. 2 is a flowchart illustrating an operation example of the control system 10 according to the first example embodiment. The detection unit 101 detects the face of the person using the sensor (step S101). The control unit 102 displays the screen in such a way as to have a predetermined height, a predetermined position, a predetermined orientation, and a predetermined size with the imaging device (step S102).

For example, the control unit 102 determines whether a specific screen is being displayed (step S103). In a case where it is determined that the specific screen is not displayed (step S103: No), the control unit 102 returns the process to step S103. On the other hand, in a case where it is determined that the specific screen is being displayed (step S103: Yes), the control unit 102 performs control to change at least any one of the height, the position, the orientation, and the size of the aerial image formation that displays the specific screen based on the position of the detected face of the person while the specific screen is being displayed (step S104). The control system 10 ends the process.

A general display can be easily peeped at. Although it is possible to prevent peeping by using a peeping prevention filter or the like, it may be difficult for the user to see the display on which the peeping prevention filter is applied. The aerial display has a narrow viewing angle and strong display directivity. Therefore, the aerial display is less likely to be peeped at than a general display. However, even in an aerial display, it is required to further suppress peeping. In order to prevent peeping, for example, when a table on which the aerial display is installed is surrounded by an object such as a plate, it is difficult to use the table as a simple table when display is not performed, and the effect of the aerial display cannot be utilized. For example, in the case of a retail store, it is assumed that the table is used as a bagging table. As described above, for example, depending on a use scene of a facility using a non-contact display, it is assumed that the user changes one after another. At this time, for example, there is a case where the user does not want to another person to peep depending on a screen in a case where personal information is displayed.

Therefore, in the first example embodiment, when a specific screen among the plurality of screens is displayed, the control system 10 performs control to change at least any one of the height, the position, the orientation, and the size of the aerial image formation displayed by the aerial display from the default mode based on the position of the detected face of the person. As a result, according to the control system 10, when the person is another person other than the user of the aerial display, a specific screen can be displayed in such a way that the another person is hard to see. Therefore, it is possible to suppress peeping. Since the aerial display has a narrow viewing angle, it may be difficult for some users to see the display in the default mode. Therefore, according to the control system 10, when the person is a user of the aerial display, a specific screen can be displayed in such a way that the user can easily see the screen. Since the aerial display has a narrow viewing angle, when the user can easily see the aerial image formation, there is a high possibility that it is difficult for a person other than the user to see the aerial image formation. Therefore, it is possible to suppress peeping.

### Second Example Embodiment

Next, the second example embodiment will be described in detail with reference to the drawings. In the second example embodiment, a specific method of controlling the height, the position, the orientation, and the size of aerial image formation will be described. Specifically, in the second example embodiment, a retail store will be described as an example of a facility using an aerial display. In the second example embodiment, hereinafter, the description of content overlapping with the above description will be omitted to the extent that the description of the second example embodiment is not unclear.

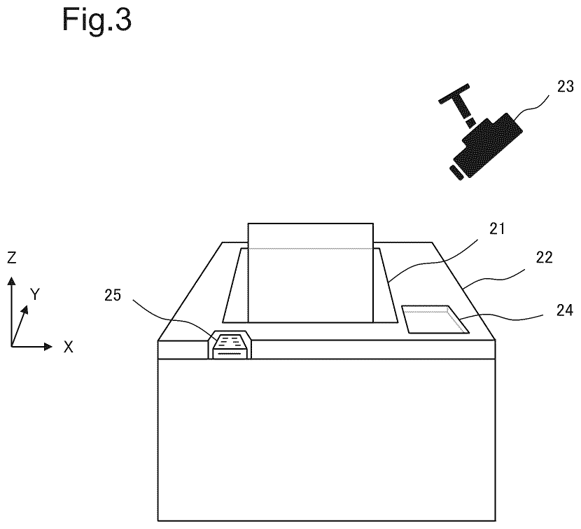

FIG. 3 is an explanatory diagram illustrating an example in which the aerial display is used as a display device of the POS system. For example, a table 22, an aerial display 21, and an imaging device 23 are installed in the store. The aerial display 21 is installed on the table 22. In addition to the aerial display 21, a reading device 24 that reads a code of a product, a card reading device 25 including an input device such as a numeric keypad, and the like may be installed on the table 22. The imaging device 23 is used as a sensor that detects a face of a customer. For example, the imaging device 23 captures an image of a range in which a person at a position where aerial image formation of the aerial display 21 can be visually recognized can be captured. The number of imaging devices 23 may be plural and is not particularly limited. In the following drawings, the reading device 24, the card reading device 25, and the like may not be illustrated.

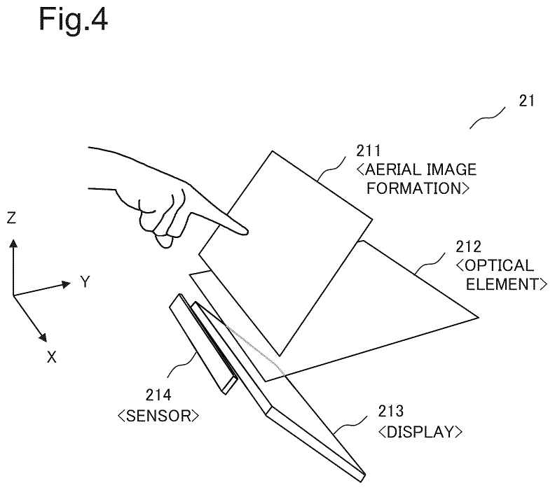

FIG. 4 is an explanatory diagram simply illustrating the aerial display 21. In FIG. 4, for ease of explanation, an X axis is defined in a lateral direction, a Y axis is defined in a depth direction, and a Z axis is defined in a height direction. The aerial display 21 includes, for example, an optical element 212, a display 213, and a sensor 214.

In the aerial display 21, the optical element 212 transmits light rays emitted by the display of the display 213 and forms an image same as the display of the display 213 at a position opposite to that of the display 213. In FIG. 4, this image is an aerial image formation 211. The aerial image formation 211 is transmitted. The sensor 214 is used to operate an aerial video. The sensor 214 is, for example, a motion sensor. In the following description, for example, an operation that can be detected by the sensor 214 is also referred to as an operation on the aerial display 21. The type of the aerial display 21 is not particularly limited.

The aerial display 21 may include a mechanism capable of controlling the angle between the optical element 212 and the display 213 in order to control the position, the orientation, and the like of the aerial image formation 211.

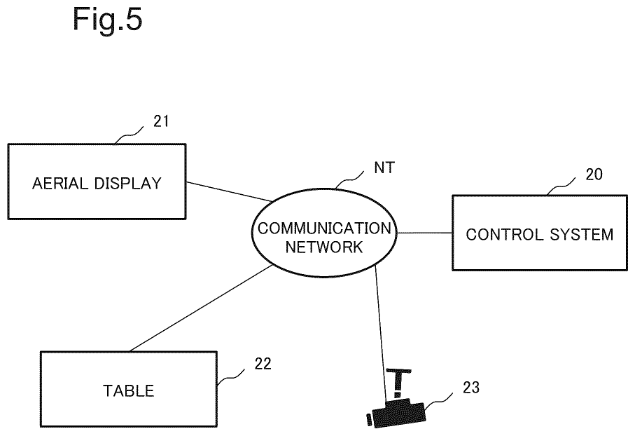

FIG. 5 is an explanatory diagram illustrating an example of connection between the control system and another device. The control system 20 is connected to the table 22 via the aerial display 21, the imaging device 23, and a communication network NT. In a case where the height of the table 22 is controllable, the control system 20 is connected to the table 22 via the communication network NT.

The control system 20 may include a POS system, or may be connected to the POS system via the communication network NT. For example, the POS system is only required to use an existing technology, and includes, for example, a product registration unit that registers a product, a payment unit that pays for a registered product, and the like.

The communication network NT may be a plurality of communication networks. For example, a communication network in which the control system 20 and the aerial display 21 are connected, a communication network in which the control system 20 and the imaging device 23 are connected, and a communication network in which the control system 20 and the table 22 are connected may be different.

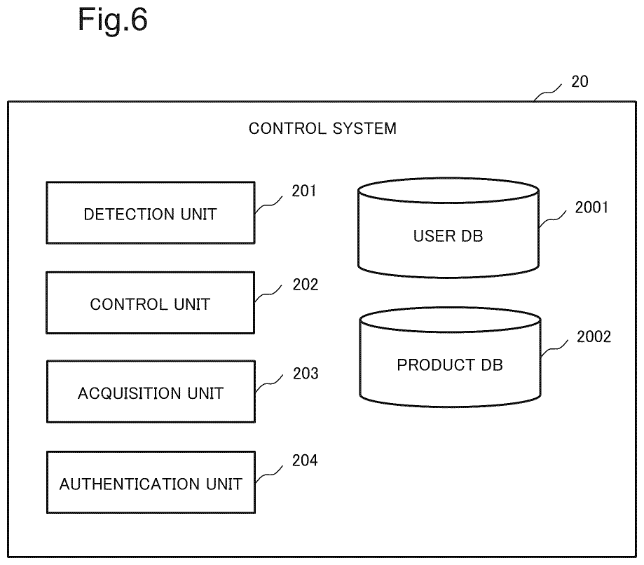

FIG. 6 is a block diagram illustrating a configuration example of the control system 20 according to the second example embodiment. The control system 20 includes a detection unit 201, a control unit 202, an acquisition unit 203, and an authentication unit 204.

The control system 20 is different from the control system 10 according to the first example embodiment in that the acquisition unit 203 and the authentication unit 204 are added. The detection unit 201 has the function of the detection unit 101 according to the first example embodiment as a basic function. The control unit 202 has the function of the control unit 102 according to the first example embodiment as a basic function.

For example, the control system 20 includes a user database (DB) 2001 and a product DB 2002. Each functional unit of the control system 20 can appropriately refer to or update various pieces of databases.

The user DB 2001 stores, for each user, biometric data of the user, physical data of the user, attribute data of the user, and point information of the user. For example, the user DB 2001 stores user identification information, biometric data, physical data, and attribute data of the user in association with each other. For example, the user identification information is not particularly limited as long as the user can be identified. For example, the user identification information may be a point card number. The biometric data is user information used for biometric authentication. Specifically, the biometric data is information such as a fingerprint, an iris, a vein, a face, a voice, and an ear pattern. The physical data is information about the body such as the height of the user. For example, the attribute data is information such as age, sex, and body. For example, the point information is information indicating a value of points usable in a store.

The product DB 2002 stores product information for each product. For example, the product DB 2002 stores product identification information and product information in association with each other. The product identification information is not particularly limited as long as the product identification information can uniquely identify the product, such as a product code. The product information is information such as a name of a product, a price of the product, and a category of the product. The category of the product may be different depending on the business aspect of the store. Taking a case where the store is a supermarket as an example, the category of the product may be a large category such as food, daily necessities, and medicine, or may be a small category such as vegetables, meats, and dairy products.

Next, each function unit will be described.

As described in the first example embodiment, detection unit 201 detects the face of the person using the sensor. For example, in a case where the sensor is the imaging device 23, the detection unit 201 detects the face of the person from the image captured by the imaging device 23. A case where the persons are the user of the aerial display 21 and another person other than the user of the aerial display 21 will be described. In a case where the aerial display 21 is used as the display device of the POS system, the user of the aerial display 21 is a customer who performs product registration and payment.

First, a case where the person is a user of the aerial display 21 will be described.

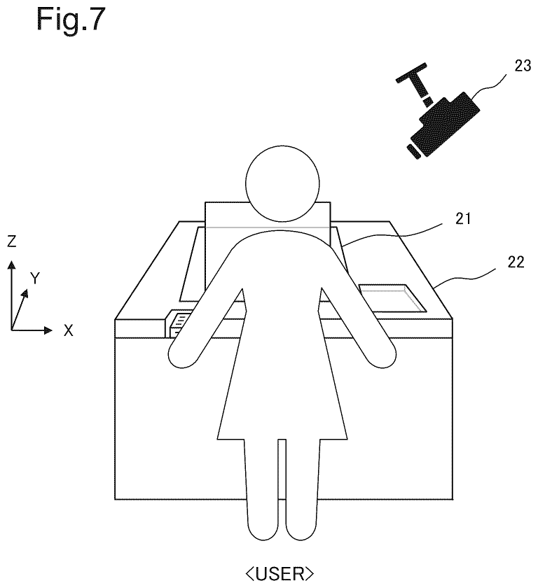

FIG. 7 is an explanatory diagram illustrating an example in which the user's face is detected by the imaging device 23. The detection unit 201 detects the face of the user from the image captured by the imaging device 23.

The detection unit 201 may detect the position of the face of the person. For example, the position of the face is at least any one of the height of the face, the position of the eye of the face, and the position of the face with respect to the aerial display 21. As described above, the position of the face of the person may be an absolute position or a relative position.

The control unit 202 performs control in such a way that the aerial image formation 211 of the aerial display 21 includes a predetermined height, a predetermined position, a predetermined orientation, and a predetermined size when displaying a screen other than a specific screen among a plurality of screens to be displayed by the aerial display 21. The predetermined height, the predetermined position, and the predetermined orientation may be determined based on an average height of a general user. The predetermined size may be the entire display region of the display 213 included in the aerial display 21.

There are various methods for controlling the height, the position, the orientation, and the size, and the method is not particularly limited. First, as a method of controlling either the position or the orientation of the aerial image formation 211, for example, the control unit 202 controls at least either the position of the aerial image formation 211 or the orientation of the aerial image formation 211 by controlling the angle between the display 213 included in the aerial display 21 and the optical element 212 included in the aerial display 21.

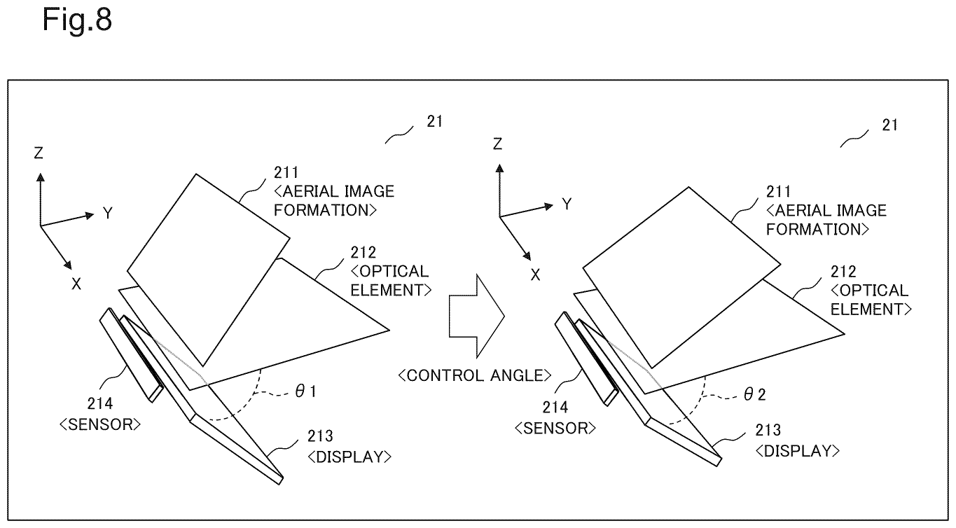

FIG. 8 is an explanatory diagram illustrating an example in which the angle between the display 213 included in the aerial display 21 and the optical element 212 included in the aerial display 21 is controlled. In FIG. 8, the control unit 202 changes the angle between display 213 and optical element 212 from an angle θ1 to an angle θ2. As a result, the orientation of the aerial image formation 211 and the position of the aerial image formation 211 are changed. In the example of FIG. 8, since the angle θ2 is smaller than the angle θ1, the angle between the aerial image formation 211 and the optical element 212 is reduced after the angle between the display 213 and the optical element 212 is controlled. As a result, the position and the orientation of the aerial image formation 211 are changed.

As a method of controlling any of the position and the size of the aerial image formation 211, the control unit 202 can control at least any one of the position and the size of the aerial image formation 211 of the aerial display 21 by controlling the display of the display 213 included in the aerial display 21. More specifically, for example, the control unit 202 controls the position and the size of the aerial image formation 211 of the aerial display 21 by changing a region to be used in the display region of the display 213 included in the aerial display 21.

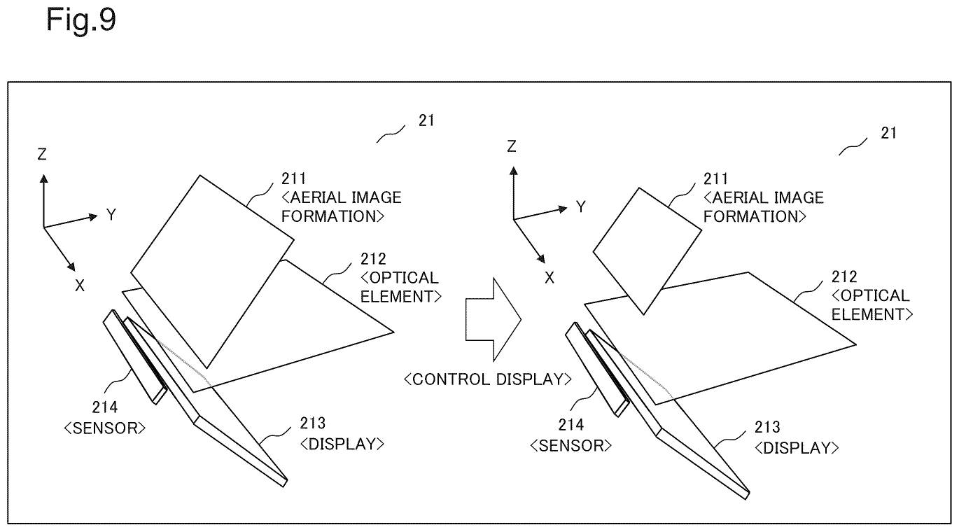

FIG. 9 is an explanatory diagram illustrating an example in which display of the display 213 included in the aerial display 21 is controlled. The control unit 202 changes the display of the entire display region of the display 213 included in the aerial display 21 to the display of a partial region of the display region. As a result, in FIG. 9, the size of the aerial image formation 211 of the aerial display 21 is reduced.

As a method of controlling the height of the aerial image formation 211, for example, the control unit 202 controls the height of the aerial image formation 211 of the aerial display 21 by controlling the height of the table 22 on which the aerial display 21 is installed.

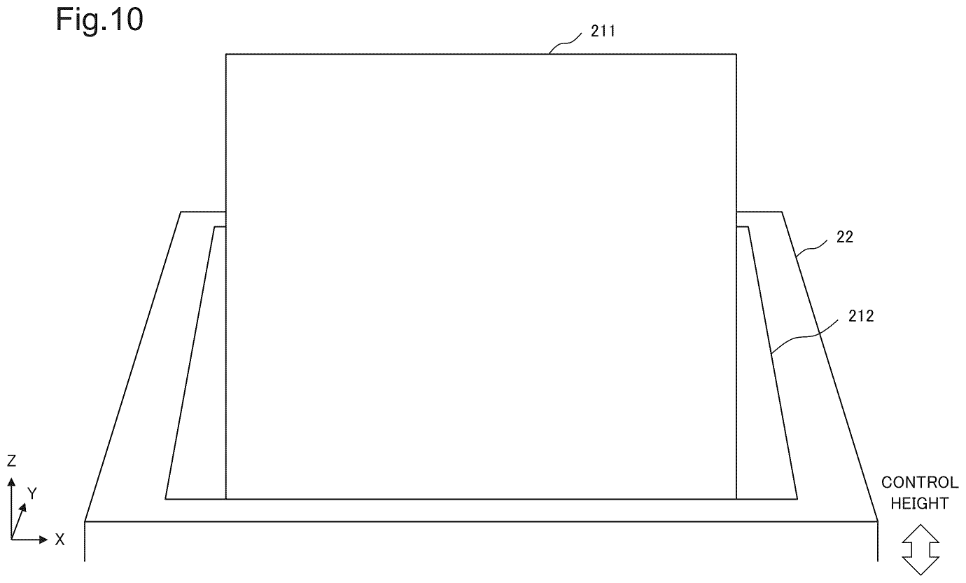

FIG. 10 is an explanatory diagram illustrating an example in which the height of the table 22 is controlled. For example, the control unit 202 controls the height of the table 22 on which the aerial display 21 is installed. As a result, the height of the aerial image formation 211 of the aerial display 21 changes.

The control methods may be used in combination.

Next, when the specific screen is displayed, the control unit 202 performs control to change at least any one of the height, the position, the orientation, and the size of the aerial image formation 211 that displays the specific screen based on the position of the detected face of the person. As the changing method, for example, at least any one of the control methods may be used. The specific screen is not particularly limited. For example, as described in the first example embodiment, the specific screen may be a screen including personal information.

The specific screen may be a screen including point information usable in a store. Generally, for example, in the POS system, in the product registration, the product is registered in the product registration list of the user after the product code is acquired. The registration screen may include product information such as the name and price of the product registered in the product registration list. Some users may not want another person to see what they are purchasing. Therefore, the specific screen may be a registration screen including the product information of the registered product. The user may allow another person to see that the user is performing purchasing depending on the product, but may not want another person to see that the user is performing purchasing depending on the product. Therefore, the specific screen may be a registration screen of a specific product. The specific product is not particularly limited. For example, depending on the medicine, it may be possible to estimate a disease or the like of the user. Therefore, the specific screen may be a registration screen of a product whose category of the product included in the product DB 2002 is a medicine.

The specific screen may be a payment screen at the time of payment. The payment screen is a payment method selection screen, a payment screen, or the like.

Specifically, for example, in a case where the size of the aerial image formation 211 is changed while a specific screen is displayed, the control unit 202 may change the size of the aerial image formation 211 for displaying the specific screen to a predetermined size or less. That is, the control unit 202 may perform control in such a way as to be equal to or smaller than the size of the aerial image formation 211 in the default mode. As a result, it is possible to make it more difficult for a person other than the user to see. However, in a case where the aerial image formation 211 is too small, it may be difficult for some users to see. Therefore, the control unit 202 further performs control to change the size of the aerial image formation 211 based on the attribute of the user. For example, the attribute of the user may be an attribute represented by the attribute data of the user included in the user DB 2001, or may be estimated from an image captured by the imaging device 23. For example, the attribute may be age, age period, or the like, and is not particularly limited. For example, when the age of the user is low, the user may see the aerial image formation 211 even when it is small. On the other hand, in a case where the age of the user is high, there is a possibility that it is difficult for the user to see the aerial image formation 211 if it is small. Therefore, in a case where the size of the aerial image formation 211 is reduced, the control unit 202 performs control to change the size of the aerial image formation 211 according to the age.

For example, in a case where the height of the aerial image formation 211 is changed while a specific screen is displayed, for the height of the aerial image formation 211 that displays a specific screen, the control unit 202 identifies the height of the aerial image formation 211 that the user can easily visually recognize from the position of the face of the user based on the position of the detected face of the person and the viewing angle of the aerial display 21. The control unit 202 controls the aerial image formation 211 to have the identified height. As a result, the user can easily see the aerial image formation 211.

For example, in a case where the orientation of the aerial image formation 211 is changed when a specific screen is displayed, the control unit 202 identifies the orientation of the aerial image formation 211 that the user can easily visually recognize from the position of the face of the user based on the position of the detected face of the person and the viewing angle of the aerial display 21. The control unit 202 controls the aerial image formation 211 to have the identified orientation. As a result, the user can easily see the aerial image formation 211.

For example, in a case where the position of the aerial image formation 211 is changed when a specific screen is displayed, the control unit 202 identifies the orientation of the aerial image formation 211 that the user can easily visually recognize from the position of the face of the user based on the position of the detected face of the person and the viewing angle of the aerial display 21. The control unit 202 perform control in such a way that the aerial image formation 211 includes the identified position. As a result, the user can easily see the aerial image formation 211.

Which of the height, the position, the orientation, and the size of the aerial image formation 211 is changed may be determined by the control unit 202 or may be determined in advance.

The control unit 202 displays specific information at a specific position of the aerial image formation 211. The specific position is, for example, a position that is difficult for a person other than the user to see. Specifically, the specific position is, for example, a central position on the lower side of the aerial image formation 211. The specific information is not particularly limited, but may be, for example, important information. For example, the specific information may be personal information, point information, or the like.

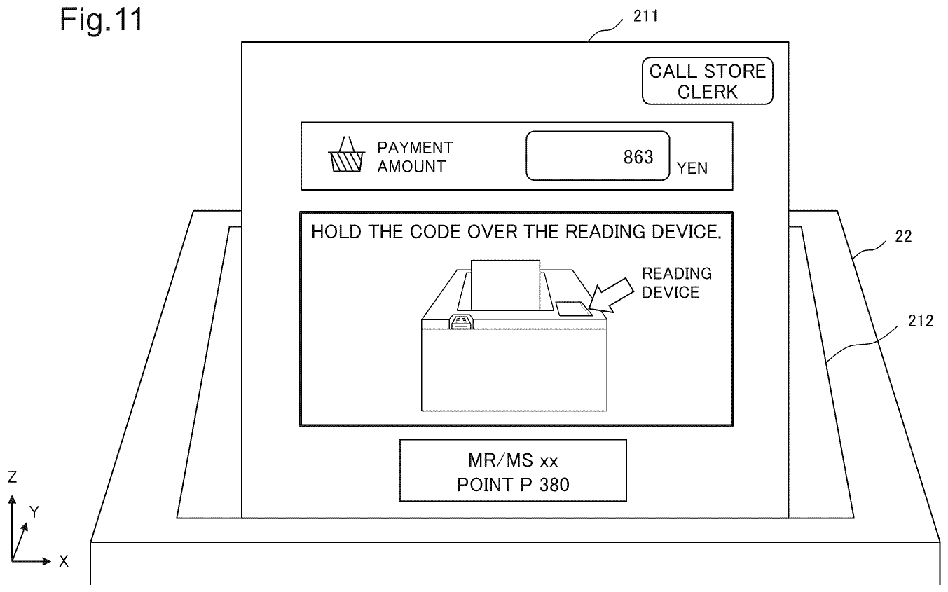

FIG. 11 is an explanatory diagram illustrating an example in which the name of the user and the point information are displayed at specific positions. The control unit 202 performs control to display the name of the user and the point information at the lower center position of the aerial image formation 211 on which the specific screen is displayed. For example, when the user stands in front of the aerial display 21, it is possible to make it difficult for another person other than the user to see the name of the user and the point information. Therefore, peeping can be suppressed.

The aerial display 21 may have a narrow viewing angle. For example, in a case where the position of the face of the user to be detected is the height of the face, the control unit 202 displays specific information at a position in the aerial image formation 211 based on the height of the face of the person and the viewing angle of the aerial display. For example, the control unit 202 identifies a position at which the user can easily see in the aerial image formation 211 based on the height of the face of the person and the viewing angle of the aerial display. The control unit 202 displays specific information at a position where the user can easily see the specific information. The specific information is as described above. Accordingly, display suitable for the user is performed. Therefore, it is possible to obtain the effect that the user of the aerial display 21 can easily see the display while maintaining the effect that it is difficult for another person to peep.

Biometric authentication may be performed. For example, the acquisition unit 203 acquires, for each user, data in which biometric data of the user and physical data indicating the height of the user are associated with each other. This data is the user DB 2001. The user DB 2001 may be acquired from the POS system, and is not particularly limited.

The authentication unit 204 may perform biometric authentication. The type of biometric authentication is not particularly limited. For example, face authentication will be described as an example. For example, in the case of the face authentication, the authentication unit 204 performs the face authentication based on the image of the user captured by the imaging device 23. For example, the position of the face may be identified by the height indicated by the physical data of the authenticated user included in the user DB 2001. In a case where the position of the face is the height of the face, the height of the face can be identified from the height indicated by the physical data.

Next, a case where the person detected by the detection unit 201 is another person other than the user of the aerial display 21 will be described. The detection unit 201 may detect both the user and another person other than the user.

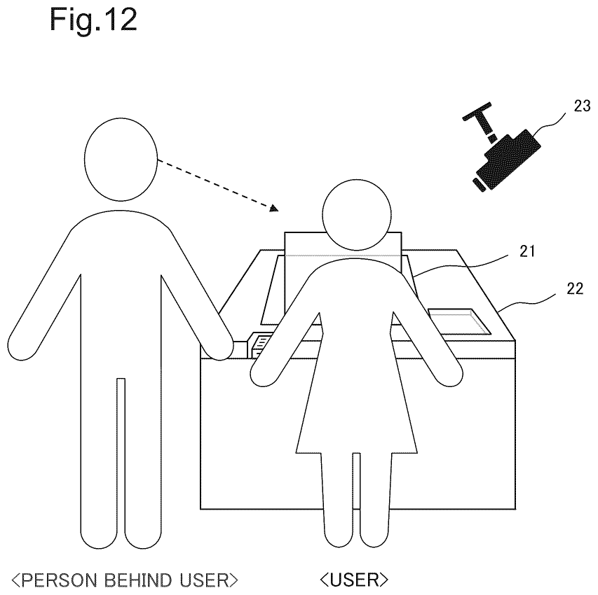

FIG. 12 is an explanatory diagram illustrating an example in which a face of another person other than the user is detected. In FIG. 12, the imaging device 23 images the user and another person other than the user. The detection unit 201 detects the user and another person other than the user from the image captured by the imaging device 23.

The detection unit 201 may determine whether the person is the user or another person other than the user based on a standing position with respect to the aerial display 21, or may identify the person by a living body such as face authentication. For example, in a case where the person is another person other than the user of the aerial display 21, the position of the face is at least any one of the position of the face with respect to the user and the position of the face with respect to the aerial display 21.

The position of the face of another person with respect to the user may be a position such as whether the another person is taller or shorter than the user, or a position such as whether the another person is left behind the user or right behind the user. As described above, the position of the face with respect to the user may be a broad position with respect to the user. Left and right are left and right in a case where the user faces in a direction in which the aerial image formation 211 can be visually recognized. In FIG. 12, for example, the minus direction of the X axis is the left side of the user, and the plus direction of the X axis is the right side of the user. In FIG. 12, the another person is at the left side with respect to the user and is taller than the user. In FIG. 12, for example, the minus direction of the Z axis is the lower side, and the plus direction of the Z axis is the upper side.

The position of the face of another person with respect to the user may be a coordinate position or the like in a case where the user is centered. Alternatively, the position of the face of another person with respect to the user may be a position such as a distance in each direction with respect to the user. As described above, the position of the face with respect to the user may be a detailed position with respect to the user.

The position of the face with respect to the aerial display 21 may be a broad position such as the left side or the right side of the aerial image formation 211 of the aerial display 21, or may be a detailed position, such as a distance in each direction with respect to the aerial display 21.

Based on the position of the detected face of another person, the control unit 202 changes at least any one of the size of the aerial image formation 211 and the position of the aerial image formation 211. In order to prevent peeping, the control unit 202 may bring the display of the aerial image formation 211 to a position or a size that is difficult for another person to see in such a way that it is difficult for another person to see the aerial image formation 211.

An example in which by changing the display of the display 213 included in the aerial display 21, the size and the position of the aerial image formation 211 are changed will be described. The description will be given on the assumption that the upper, lower, left, and right of the display 213 included in the aerial display 21 coincide with the upper, lower, left, and right of the aerial image formation 211.

For example, in a case where another person is taller than the user, the control unit 202 performs display using a lower region in the display region of the display 213 included in the aerial display 21. As a result, the aerial image formation 211 is bought downward. For example, in a case where another person is shorter than the user, the control unit 202 performs display using an upper region in the display region of the display 213 included in the aerial display 21. As a result, the aerial image formation 211 is bought upward. Therefore, it is difficult for another person to see a specific screen displayed as the aerial image formation 211.

For example, in a case where another person is left behind the user, the control unit 202 performs display using the right display region in the display region of the display 213 included in the aerial display 21. As a result, the aerial image formation 211 is bought right. For example, in a case where another person is right behind the user, the control unit 202 performs display using the left display region in the display region of the display 213 included in the aerial display 21. As a result, the aerial image formation 211 is bought left. Therefore, it is difficult for another person to see a specific screen displayed as the aerial image formation 211.

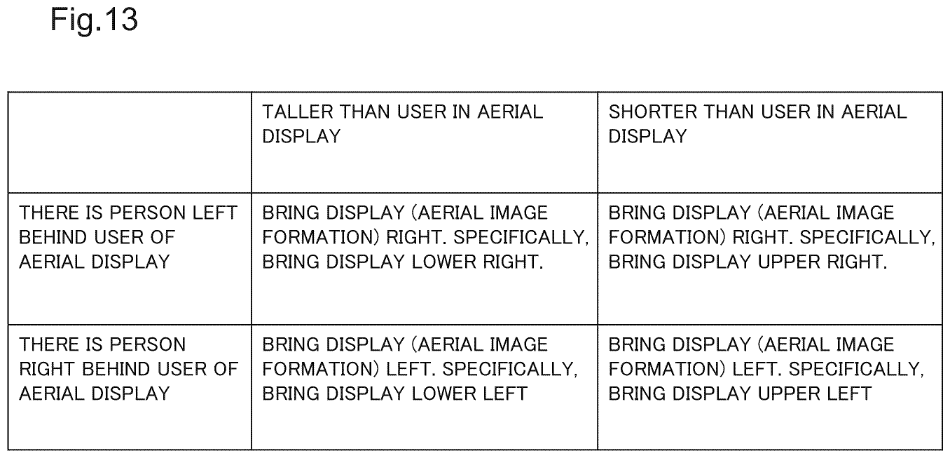

FIG. 13 is an explanatory diagram illustrating a display position example of the aerial image formation 211 for each position of the face of another person. In FIG. 13, for example, in a case where another person is taller than the user and is left behind the user, the control unit 202 controls the display of the display 213 included in the aerial display 21 in such a way as to bring the aerial image formation 211 lower right.

In FIG. 13, for example, in a case where another person is taller than the user and is right behind the user, the control unit 202 controls the display of the display 213 included in the aerial display 21 in such a way as to bring the aerial image formation 211 lower left.

In FIG. 13, for example, in a case where another person is shorter than the user and is left behind the user, the control unit 202 controls the display of the display 213 included in the aerial display 21 in such a way as to bring the aerial image formation 211 lower right.

In FIG. 13, for example, in a case where another person is shorter than the user and is right behind the user, the control unit 202 controls the display of the display 213 included in the aerial display 21 in such a way as to bring the aerial image formation 211 lower left.

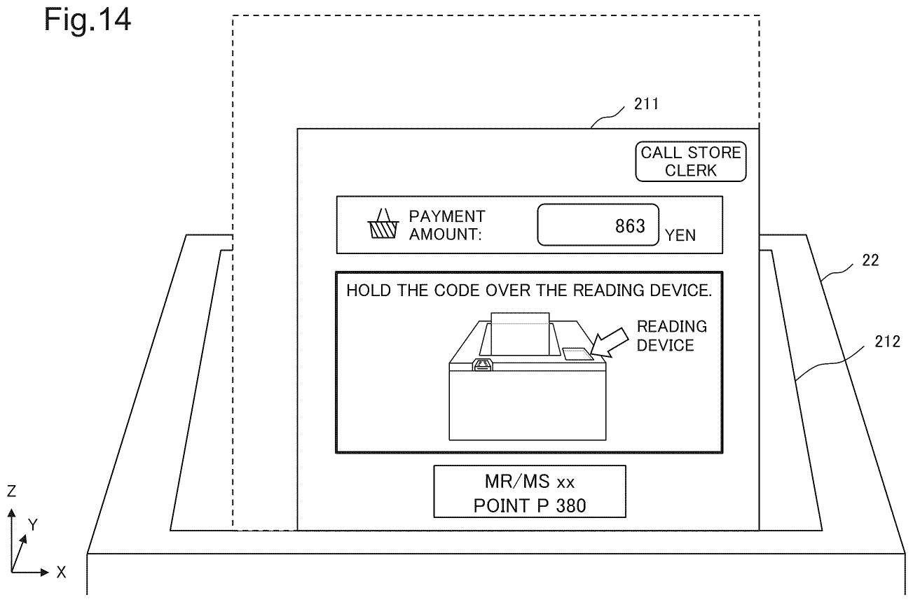

FIG. 14 is an explanatory diagram illustrating an example in which the aerial image formation 211 is brought lower right in a case where another person is taller than the user and is left behind the user. For example, in the default mode, it is assumed that each screen is displayed using the entire display region of the display 213 included in the aerial display 21. For ease of understanding, the region where the aerial image formation 211 in the default mode is displayed is represented by a dotted line. In a case where the position of the face of another person is higher than the user and is left behind the user as illustrated in FIG. 12, the control unit 202 performs control to display a specific screen in a lower right region in the display region of the display 213 included in the aerial display 21. As a result, the aerial image formation 211 is brought lower right.

In a case where it is desired to make another person see the aerial image formation 211, the display may be brought to a position opposite thereto.

The user does not want another person to peep at a specific screen, but may allow another person to see other information. Therefore, the control unit 202 may determine the size and the position of a specific screen in the aerial image formation 211 based on the position of the face of another person. The control unit 202 displays a specific screen at the determined size and position in the display region of the display 213 included in the aerial display 21, and display predetermined information in at least part of the other region. That is, any of the size and the position of the aerial image formation 211 on which a specific screen of the aerial image formation 211 is displayed is changed. The predetermined information is, for example, information that may be seen by others. The information that may be seen by others may be information such as an advertisement of a store or an advertisement of a product. The predetermined information may be information about calling attention to the presence of a person behind. The information about the call attention may be a video of a person behind captured by the imaging device 23, or may be a sentence of a call attention such as “there is a person behind”.

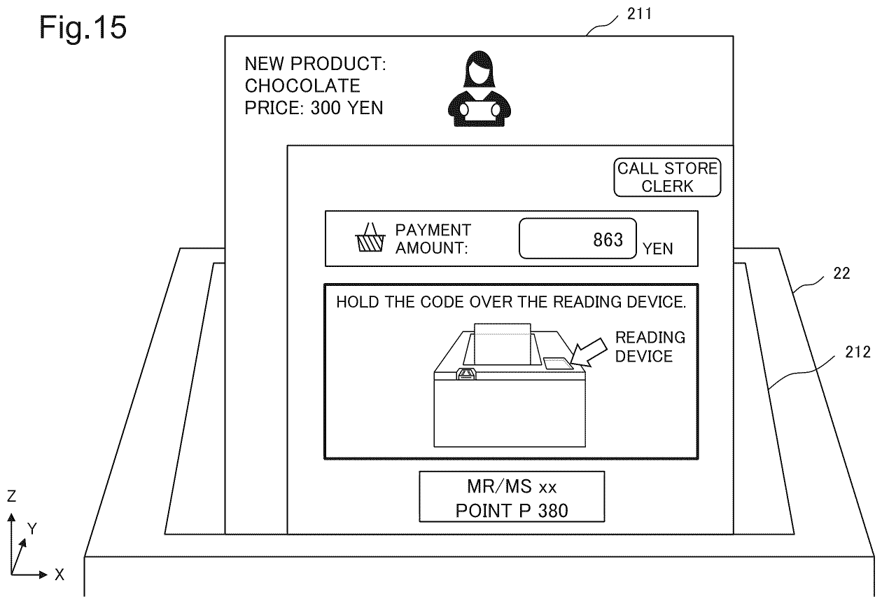

FIG. 15 is an explanatory diagram illustrating an example in which a payment screen and an advertisement of a product are included in the aerial image formation 211. In a case where the position of the face of another person is higher than the position of the face of the user as illustrated in FIG. 12 and is left behind the user, the control unit 202 displays a payment screen in the lower right region in the display region of the display 213 included in the aerial display 21, and displays a chocolate advertisement in a region other than the lower right region. The payment screen is brought lower right, and the chocolate advertisement is displayed in a margin portion of the display region other than the region where the payment screen is displayed. As a result, even when another person peeps at the aerial image formation 211, it is possible to make it difficult for the another person to see the payment screen, and the advertisement of the chocolate is peeped at. It is possible to show the user an advertisement of chocolate together with the payment screen. Therefore, the remaining display region can be effectively used.

In the above description, an example is described in which the size and the position of the aerial image formation 211 are changed by changing the display of the display 213 included in the aerial display 21, but the present invention is not particularly limited as described above as long as the position and the like of the aerial image formation 211 can be changed.

For example, in a case where a state where there is a person other than the user changes to a state where there is no person other than the user, the control unit 202 may return the mode to the default mode in a case where there is a screen transition. For example, in a case where the registration screen is updated each time a product is newly registered, the control unit 202 may return the mode to the default mode in a case where a new product is registered and a new registration screen is displayed in a case where a state where there is a person other than the user changes to a state where there is no person other than the user. In order to prevent the user from being distracted, the control unit 202 may maintain the display changed from the default mode even in a case where a state where there is a person other than the user changes to a state where there is no person other than the user.

In a case where the person is another person other than the user, the control unit 202 may change the display position of specific information on the specific screen based on the position of the face of the another person. For example, the control unit 202 displays specific information at a position that is difficult for a person other than the user to see in the aerial image formation 211.

For example, in a case where another person is taller than the user, the control unit 202 displays specific information at a lower position on the specific screen. For example, in a case where another person is shorter than the user, the control unit 202, for example, in a case where another person is taller than the user, the control unit 202 displays specific information at an upper position on the specific screen. This makes it difficult for another person to see specific information.

For example, in a case where another person is left behind the user, the control unit 202 displays specific information at the right position of the specific screen. For example, in a case where another person is right behind the user, the control unit 202 displays specific information at the left position of the specific screen. This makes it difficult for another person to see specific information.

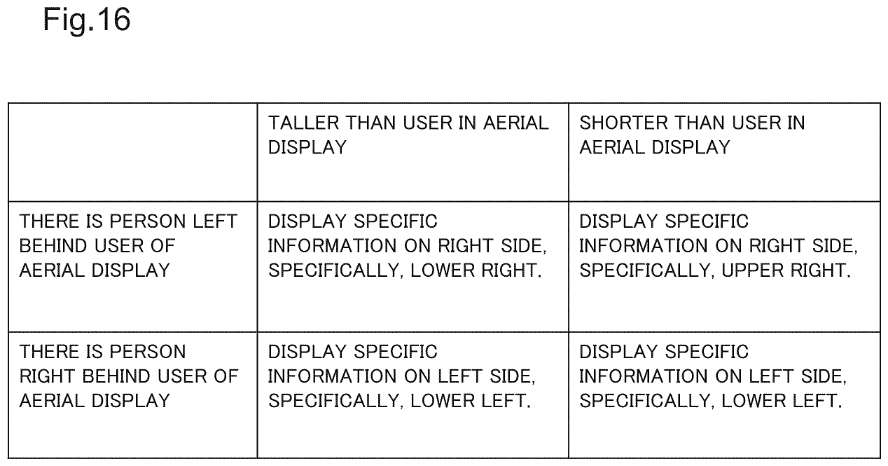

FIG. 16 is an explanatory diagram illustrating an example of the display position of the aerial image formation 211 according to the position of the face of another person. In FIG. 16, for example, in a case where another person is taller than the user and is left behind the user, the control unit 202 displays specific information at a lower right position on the specific screen.

In FIG. 16, for example, in a case where another person is taller than the user and is right behind the user, the control unit 202 displays specific information at a lower left position on the specific screen.

In FIG. 16, for example, in a case where another person is shorter than the user and is left behind the user, the control unit 202 displays specific information at a lower right position on the specific screen.

In FIG. 16, for example, in a case where another person is shorter than the user and is right behind the user, the control unit 202 displays specific information at a lower left position on the specific screen.

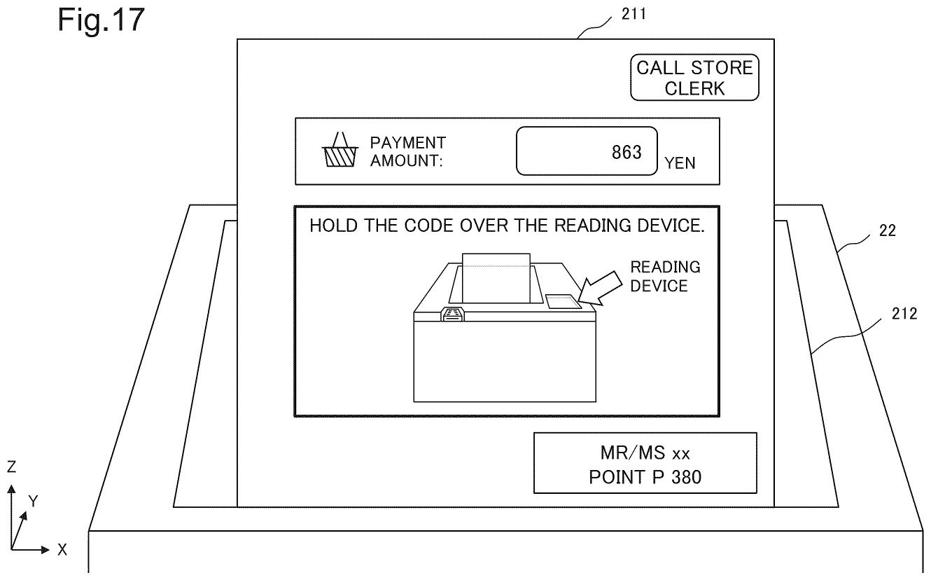

FIG. 17 is an explanatory diagram illustrating an example in which the name of the user and the point information are displayed in the lower right in a case where another person is taller than the user and is left behind the user. In a case where the position of the face of another person is higher than the position of the user and is left behind the user as illustrated in FIG. 12, the control unit 202 performs control to display the name of the user and the point information at the lower right position on the specific screen.

In the above description, examples may be combined. For example, the detection unit 201 may detect both the user and a person other than the user. When the specific screen is displayed, the control unit 202 may change at least any one of the height, the position, the orientation, and the size of the aerial image formation 211 that displays the specific screen based on the position of the face of the user and the position of the face of another person other than the user.

For example, in FIG. 14, the point information is displayed at the lower center in the aerial image formation 211 of the specific screen. In a case where a person other than the user is taller than the user and is left behind the user, the control unit 202 may display the point information at the lower right in the specific screen. As a result, it is possible to make it difficult for another person other than the user to see the point information.

### Flowchart

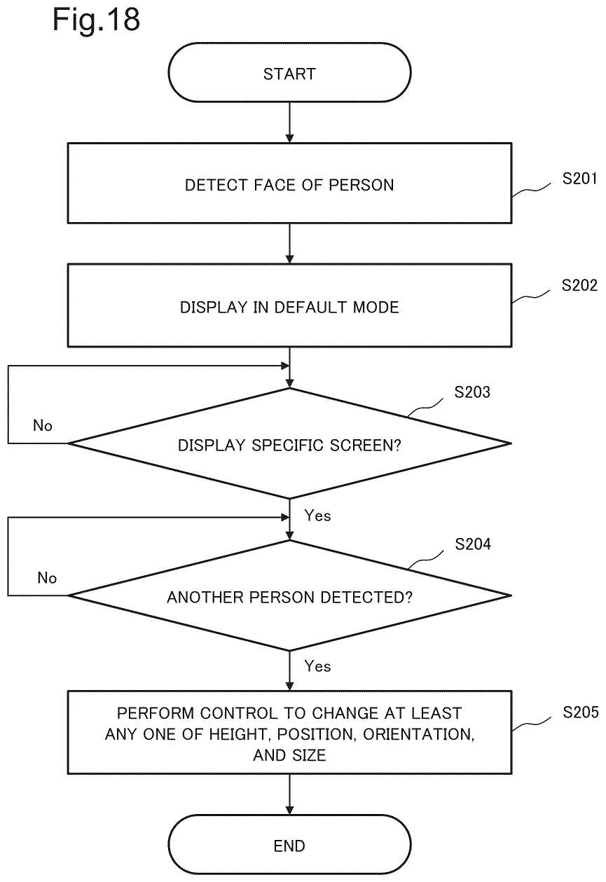

FIG. 18 is a flowchart illustrating an operation example of the control system 20 according to the second example embodiment. In FIG. 18, an example will be described in which, in a case where both the user and another person other than the user are detected, at least any one of the height, the position, the orientation, and the size of the aerial image formation 211 that displays the specific screen is changed while the specific screen is being displayed.

The detection unit 201 detects the face of the person using the sensor (step S201). The control unit 202 displays a screen in the default mode (step S202). The display of the screen in the default mode is display in such a way that the aerial image formation 211 includes a predetermined height, a predetermined position, a predetermined orientation, and a predetermined size.

For example, the control unit 202 determines whether a specific screen is being displayed (step S203). In a case where it is determined that the specific screen is not displayed (step S203: No), the control unit 202 returns the process to step S203. On the other hand, in a case where it is determined that the specific screen is being displayed (step S203: Yes), the control unit 202 determines whether another person other than the user is detected (step S204). In a case where no person other than the user is detected (step S204: No), the control unit 202 returns the process to step S204.

In a case where another person other than the user is detected (step S204: Yes), the control unit 202 performs control to change at least any one of the height, the position, the orientation, and the size of the aerial image formation 211 that displays the specific screen based on the position of the face of the user and the position of the face of another person (step S205). The control system 20 ends the process. In a case where no other person is detected, the flowchart may be appropriately ended.

As described above, in the second example embodiment, in a case where the detected person is the user of the aerial display 21, the position of the face is at least any one of the height of the face, the position of the eye of the face, and the position of the face with respect to the aerial display 21. It is possible to display a specific screen in such a way that the user can easily see the screen. Since the aerial display 21 has a narrow viewing angle, when the user can easily see the aerial image formation 211, it is highly likely that it will be difficult for a person other than the user to see the aerial image formation 211. Therefore, it is possible to suppress peeping.

In a case where the detected person is the user of the aerial display 21, the position of the face of the person is the height of the face, and the control system 20 displays specific information at the position in the aerial image formation based on the height of the face of the person and the viewing angle of the aerial display 21. The specific information may be, for example, important information such as personal information. The viewing angle of the aerial display 21 is determined in advance. Therefore, in the aerial image formation 211 displayed by the aerial display 21, it is possible to display important information at a position that is seen by the user and difficult to see by another person.

The control system 20 displays specific information at a specific position of the aerial image formation 211. For example, the specific position may be the lower center of the aerial image formation 211. For example, the lower center of the aerial image formation 211 is a position that is difficult to see even if another person other than the user stands on either the right side or the left side. This makes it possible to prevent peeping at specific information.

In a case where the detected person is another person other than the user of the aerial display 21, the position of the face of the person is at least any one of the position of the face of the person with respect to the user and the position of the face of the person with respect to the aerial display 21. The control system 20 changes at least any one of the size and the position of the aerial image formation 211 based on the position of the face of another person.

In a case where the detected person is another person other than the user of the aerial display 21, the control system 20 displays specific information at a position on the specific screen based on the position of the face of the another person.

In a case where the detected person is another person other than the user of the aerial display 21, the control system 20 determines the size and the position of the specific screen in the aerial image formation 211 based on the position of the face of the another person. The control system 20 displays a specific screen at the determined size and position in the display region that can be displayed by the display 213 included in the aerial display 21, and displays predetermined information in another region.

The control system 20 performs biometric authentication, and performs control to change at least any one of the height, the position, the orientation, and the size of the aerial image formation 211 based on the position of the user's face according to the height indicated by the physical data of the user authenticated by the biometric authentication. As a result, when the biometric authentication can be performed, it is possible to display the aerial image formation 211 that is easy for the user to see without newly detecting the position of the user's face.

In the second example embodiment, as a display example of a screen using the aerial display 21, a screen display of product registration and payment in a retail store is described as an example. As described above, the facility is not limited to a retail store, and examples thereof include a government office, a hospital, an accommodation facility such a hotel, a station, or an airport.

For example, in a case where the aerial display 21 is used in a government office, it is assumed that personal information such as an address, a revenue, a property, and a tax amount is input and output. The specific screen may be a screen for inputting or outputting such personal information.

For example, in a case where the aerial display 21 is used in a hospital, it is assumed that personal information such as an address, a medical history, and a prescription content is input and output. The specific screen is a screen for inputting and outputting such personal information.

For example, in a case where the aerial display 21 is used at an accommodation facility, a station, or an airport, it is assumed that personal information such as a name and an address is input and output. For example, check in is performed at an accommodation facility or an airport. The specific screen is a screen for inputting and outputting such personal information.

The description of each example embodiment is ended. The example embodiments can be variously changed. The modification will be described below.

### First Modification

In each example embodiment, an example is described in which the control system 20 detects the position of the face of the person, and changes at least any one of the height, the position, the orientation, and the size of the aerial image formation 211 based on the position of the detected face of the person when a specific screen is displayed. For example, the control system 20 may detect the user in front of the aerial display 21, and control at least any one of the height, the position, the orientation, and the size of the display of the aerial display 21 according to the position of the face of the user. As a result, the aerial image formation 211 according to the user is displayed. Therefore, there is an effect that the user can easily see the display while maintaining the effect that it is difficult to peep. Furthermore, in a case of detecting another person other than the user while the user is using the aerial display 21, the control system 20 may control at least any one of the position and the size of the display of the aerial display 21 according to the position of the face of the another person.

The description of the modification is ended. The respective example embodiments and modification may be used in appropriate combination.

In each example embodiment, the control system 10, 20 may include each functional unit and part of information.

The example embodiments are not limited to the examples described above, and various modifications can be made. The configuration of the control system 10, 20 in the example embodiments is not particularly limited. For example, the control system 20 may be achieved by one device such as one server. In a case where each functional unit of the control system 20 is implemented by one device, for example, one device may be referred to as a control device, an information processing device, or the like, and is not particularly limited. Alternatively, the control system 10, 20 in the example embodiments may be achieved by devices different for each function or data. For example, each functional unit may be configured by a plurality of servers and be implemented as the control system 10, 20. For example, the control system 10, 20 may be achieved by a database server including each database (DB) and a server including each functional unit.

In each example embodiment, each piece of information and each DB may include part of the information described above. Each piece of information and each DB may include information other than the above-described information. Each piece of information or each DB may be divided into a plurality of DBs or a plurality of pieces of information in more detail. As described above, a method of achieving each piece of information and each DB is not particularly limited.

Each screen is an example, and is not particularly limited. In each screen, a button, a list, a checkbox, an information display field, an input field, and the like (not illustrated) may be added. The background color of the screen and the like may be changed.

The processing of generating information and the like to be displayed on the aerial display 21 may be performed by the control unit 202. This processing may be performed by the aerial display 21. In a case where the POS system is used as in the second example embodiment, this processing may be performed by the POS system.

### Hardware Configuration Example of Computer

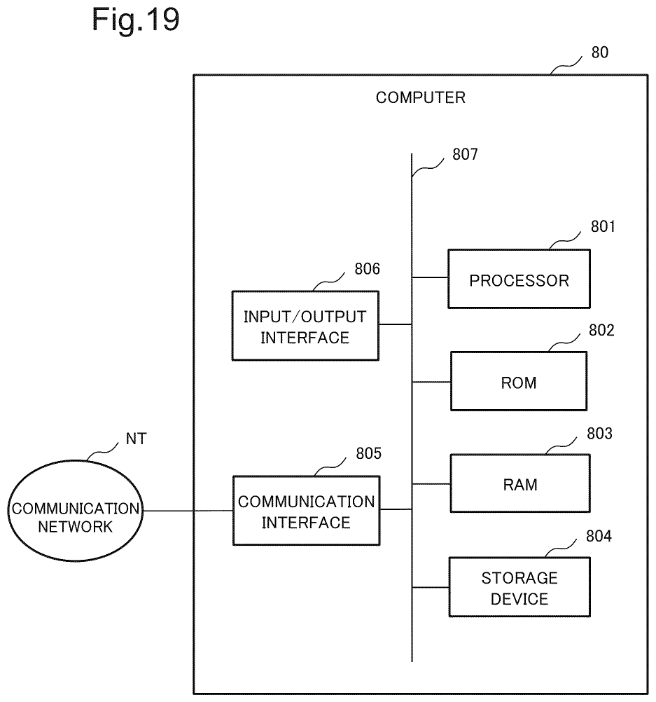

Next, a hardware configuration example in a case where each device such as the control system 10, 20 and the aerial display 21 described in each example embodiment is achieved by a computer will be described. FIG. 19 is an explanatory diagram illustrating a hardware configuration example of a computer. For example, part or all of each device can be achieved by using an any combination of a computer 80 and the program as illustrated in FIG. 19.

The computer 80 includes, for example, a processor 801, a read only memory (ROM) 802, a random access memory (RAM) 803, and a storage device 804. The computer 80 includes a communication interface 805 and an input/output interface 806. The components are connected via a bus 807. The number of each component is not particularly limited, and each component is one or more.

The processor 801 controls the entire computer 80. Examples of the processor 801 include a central processing unit (CPU), a digital signal processor (DSP), and a graphics processing unit (GPU). The computer 80 includes the ROM 802, the RAM 803, the storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. The RAM 803 is used as a work area of the processor 801.

The processor 801 loads a program stored in the storage device 804, the ROM 802, or the like. The processor 801 executes each process coded in the program. The processor 801 may download various programs via the communication network NT. The processor 801 functions as part or all of the computer 80. The processor 801 may execute processes or instructions in the flowchart illustrated based on the program.

The communication interface 805 is connected to the communication network NT such as a local area network (LAN) or a wide area network (WAN) through a wireless or wired communication line. The communication network NT may include a plurality of communication networks NT. As a result, the computer 80 is connected to an external device or an external computer 80 via the communication network NT. The communication interface 805 manages an interface between the communication network NT and the inside of the computer 80. The communication interface 805 controls an input/output of data from the external device or the external computer 80.

The input/output interface 806 is connected to at least any one of an input device, an output device, and an input/output device. The connection method may be wireless or wired. Examples of the input device include a keyboard, a mouse, and a microphone. Examples of the output device include a display device, a lighting device, and a sound output device that outputs a sound. Examples of the input/output device include a touch panel display. The input device, the output device, the input/output device, and the like may be built in the computer 80 or may be externally attached.

The hardware configuration of the computer 80 is an example. The computer 80 may have some components illustrated in FIG. 19. The computer 80 may have components other than those illustrated in FIG. 19. For example, the computer 80 may include a drive device or the like. The processor 801 may read a program or data stored in a recording medium attached to a drive device or the like into the RAM 803. Examples of the non-transitory tangible recording medium include an optical disk, a flexible disk, a magnetic optical disk, and a Universal

Serial Bus (USB) memory. As described above, for example, the computer 80 may include an input device such as a keyboard and a mouse. The computer 80 may include an output device such as a display. The computer 80 may include an input device, an output device, and an input/output device.

The computer 80 may include various sensors (not illustrated). The type of the sensor is not particularly limited. The computer 80 may include an imaging device capable of capturing images and videos.

The description of the hardware configuration of each device is ended. There are various modifications in a method of achieving each device. For example, each device may be achieved by an any combination of a computer and a program different for each component. A plurality of components included in each device may be achieved by any combination of one computer and a program.

Part or all of each component of each device may be achieved by an application specific circuit. Part or all of each component of each device may be achieved by a general-purpose circuit including a processor such as a field programmable gate array (FPGA). Part or all of each component of each device may be achieved by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

In a case where part or all of each component of each device is achieved by a plurality of computers, circuits, and the like, the plurality of computers, circuits, and the like may be disposed in a centralized manner or in a distributed manner.

The control method described in each example embodiment is implemented by the control system executing the control method. For example, the control method is implemented by a computer such as a server or a terminal device executing a program prepared in advance.

The program described in each example embodiment is recorded in a computer-readable recording medium such as an HDD, an SSD, a flexible disk, an optical disk, a flexible disk, a magnetic optical disk, or a USB memory. The program is executed by being read from the recording medium by the computer. The program may be distributed via the communication network NT.

The function of each component of the control system in each example embodiment described above may be implemented by dedicated hardware such as a computer. Alternatively, each component may be achieved by software. Alternatively, each component may be achieved by a combination of hardware and software.

While the present disclosure has been particularly shown and described with reference to each of example embodiments,
the present disclosure is not limited to the above example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### Supplementary Note 1

A control system including
a detection means for detecting a face of a person using a sensor, and
a control means for performing control in such a way that when a screen other than a specific screen among a plurality of screens to be displayed on a non-contact display is displayed, an aerial image formation of the non-contact display includes a predetermined height, a predetermined position, a predetermined orientation, and a predetermined size, wherein
the control means performs control to change at least any one of a height, a position, an orientation, and a size of the aerial image formation for displaying the specific screen based on a position of the detected face of the person when the specific screen is displayed.

### Supplementary Note 2

The control system according to Supplementary Note 1, wherein
in a case where the person is a user of the non-contact display, a position of the face is at least any one of a height of the face, a position of an eye of the face, and a position of the face with respect to the non-contact display.

### Supplementary Note 3

The control system according to Supplementary Note 1 or 2, wherein
in a case where the person is a user of the non-contact display, a position of the face is a height of the face, and
the control means displays specific information at a position in the aerial image formation based on the height of the face and a viewing angle of the non-contact display.

### Supplementary Note 4

The control system according to Supplementary Note 1 or 2, wherein
the control means displays specific information at a specific position of the aerial image formation.

### Supplementary Note 5

The control system according to any one of Supplementary Notes 1 to 4, wherein
in a case where the person is another person other than a user of the non-contact display, a position of the face is at least any one of a position of the face with respect to the user and a position of the face with respect to the non-contact display.

### Supplementary Note 6

The control system according to any one of Supplementary Notes 1 to 5, wherein
in a case where the person is another person other than a user of the non-contact display,
the control means performs control to change at least any one of a size of the aerial image formation and a position of the aerial image formation based on a position of the face of the another person in the change.

### Supplementary Note 7

The control system according to Supplementary Note 1, wherein
in a case where the person is another person other than a user of the non-contact display,
the control means displays specific information at a position on the specific screen based on a position of the face of the another person.

### Supplementary Note 8

The control system according to any one of Supplementary Notes 1 to 7, wherein
the control means performs control to change a size of the aerial image formation based on an attribute of a user of the non-contact display in the change.

### Supplementary Note 9

The control system according to any one of Supplementary Notes 1 to 8, wherein
in a case where the person is another person other than a user of the non-contact display,
the control means determines a size and a position of the specific screen in the aerial image formation based on a position of the face of the another person, displays the specific screen at the determined size and position in a region displayable by a display included in the non-contact display, and displays predetermined information in another region.

### Supplementary Note 10

The control system according to Supplementary Note 9, wherein
the predetermined information is information related to calling attention indicating that the another person is present.

### Supplementary Note 11

The control system according to Supplementary Note 9, wherein
the predetermined information is information related to an advertisement of a store or information related to an advertisement of a product.

### Supplementary Note 12

The control system according to any one of Supplementary Notes 1 to 11, wherein
the specific screen is a screen including personal information of a user of the non-contact display.

### Supplementary Note 13

The control system according to any one of Supplementary Notes 1 to 11, wherein
the specific screen is at least any one of a registration screen of a product and a payment screen of the registered product.

### Supplementary Note 14

The control system according to any one of Supplementary Notes 1 to 13, wherein
the control means controls at least any one of a position and an orientation of the aerial image formation by controlling an angle between a display included in the non-contact display and an optical element included in the non-contact display.

### Supplementary Note 15

The control system according to any one of Supplementary Notes 1 to 14, wherein
the control means changes at least any one of a position and a size of the aerial image formation by controlling display of a display included in the non-contact display.

### Supplementary Note 16

The control system according to any one of Supplementary Notes 1 to 15, wherein
the control means controls a height of the aerial image formation by controlling a height of a table on which the non-contact display is installed.

### Supplementary Note 17

The control system according to any one of Supplementary Notes 1 to 16, further including
an acquisition means for acquiring, for each user, data in which biometric data of the each user and physical data indicating a height of the each user are associated with each other, and
an authentication means for performing biometric authentication of the each user based on biometric data of a current user of the non-contact display and the acquired biometric data, wherein
the authentication means performs the biometric authentication in a case where the person is a user of the non-contact display, and
the control means performs control to change at least any one of a height, a position, an orientation, and a size of the aerial image formation based on a position of a face of the user according to a height represented by physical data of the authenticated user when the specific screen is displayed.

### Supplementary Note 18

A control method including
detecting a face of a person using a sensor, and
performing control in such a way that when a screen other than a specific screen among a plurality of screens to be displayed on a non-contact display is displayed, an aerial image formation of the non-contact display includes a predetermined height, a predetermined position, a predetermined orientation, and a predetermined size, wherein
the performing control includes performing control to change at least one of a height, a position, an orientation, and a size of the aerial image formation for displaying the specific screen based on a position of the detected face of the person when the specific screen is displayed.

### Supplementary Note 19

A computer-readable tangible recording medium that records a program, the program causing a computer to execute the steps of
detecting a face of a person using a sensor, and
performing control in such a way that when a screen other than a specific screen among a plurality of screens to be displayed on a non-contact display is displayed, an aerial image formation of the non-contact display includes a predetermined height, a predetermined position, a predetermined orientation, and a predetermined size, wherein
the performing control includes performing control to change at least one of a height, a position, an orientation, and a size of the aerial image formation for displaying the specific screen based on a position of the detected face of the person when the specific screen is displayed.

### Supplementary Note 20

A program causing a computer to execute the steps of
detecting a face of a person using a sensor, and
performing control in such a way that when a screen other than a specific screen among a plurality of screens to be displayed on a non-contact display is displayed, an aerial image formation of the non-contact display includes a predetermined height, a predetermined position, a predetermined orientation, and a predetermined size, wherein
the performing control includes performing control to change at least one of a height, a position, an orientation, and a size of the aerial image formation for displaying the specific screen based on a position of the detected face of the person when the specific screen is displayed.

### REFERENCE SIGNS LIST

10, 20 control system
21 aerial display
22 table
23 imaging device
24 reading device
25 card reading device
80 computer
101, 201 detection unit
102, 202 control unit
203 acquisition unit
204 authentication unit
211 aerial image formation
212 optical element
213 display
214 sensor
801 processor
802 ROM
803 RAM
804 storage device
805 communication interface
806 input/output interface
807 bus
2001 user DB
2002 product DB
NT communication network

What is claimed is:

1. A control system comprising:
a memory storing instructions; and
at least one processor configured to execute the instructions to:
detect a face of a person using a sensor;
perform control in such a way that when a screen other than a specific screen among a plurality of screens to be displayed on a non-contact display is displayed, an aerial image formation of the non-contact display includes a predetermined height, a predetermined position, a predetermined orientation, and a predetermined size; and
perform control to change at least any one of a height, a position, an orientation, and a size of the aerial image formation for displaying the specific screen based on a position of the detected face of the person when the specific screen is displayed.

2. The control system according to claim 1, wherein
in a case where the person is a user of the non-contact display, a position of the face is at least any one of a height of the face, a position of an eye of the face, and a position of the face with respect to the non-contact display.

3. The control system according to claim 1, wherein
in a case where the person is a user of the non-contact display, a position of the face is a height of the face, and wherein the at least one processor is further configured to execute the instructions to:
display specific information at a position in the aerial image formation based on the height of the face and a viewing angle of the non-contact display.

4. The control system according to claim 1, wherein the at least one processor is further configured to execute the instructions to:
display specific information at a specific position of the aerial image formation.

5. The control system according to claim 1, wherein
in a case where the person is another person other than a user of the non-contact display, a position of the face is at least any one of a position of the face with respect to the user and a position of the face with respect to the non-contact display.

6. The control system according to claim 1, wherein
in a case where the person is another person other than a user of the non-contact display; wherein the at least one processor is further configured to execute the instructions to:
perform control to change at least any one of a size of the aerial image formation and a position of the aerial image formation based on a position of the face of the another person in the change.

7. The control system according to claim 1, wherein
in a case where the person is another person other than a user of the non-contact display; wherein the at least one processor is further configured to execute the instructions to:
display specific information at a position on the specific screen based on a position of the face of the another person.

8. The control system according to claim 1, wherein the at least one processor is further configured to execute the instructions to:
perform control to change a size of the aerial image formation based on an attribute of a user of the non-contact display in the change.

9. The control system according to claim 1, wherein
in a case where the person is another person other than a user of the non-contact display, wherein the at least one processor is further configured to execute the instructions to:
determine a size and a position of the specific screen in the aerial image formation based on a position of the face of the another person;
display the specific screen at the determined size and position in a region displayable by a display included in the non-contact display; and
display predetermined information in another region.

10. The control system according to claim 9, wherein
the predetermined information is information related to calling attention indicating that the another person is present.

11. The control system according to claim 9, wherein
the predetermined information is information related to an advertisement of a store or information related to an advertisement of a product.

12. The control system according to claim 1, wherein
the specific screen is a screen including personal information of a user of the non-contact display.

13. The control system according to claim 1, wherein
the specific screen is at least any one of a registration screen of a product and a payment screen of the registered product.

14. The control system according to claim 1, wherein the at least one processor is further configured to execute the instructions to:
control at least any one of a position and an orientation of the aerial image formation by controlling an angle between a display included in the non-contact display and an optical element included in the non-contact display.

15. The control system according to claim 1, wherein the at least one processor is further configured to execute the instructions to:
change at least any one of a position and a size of the aerial image formation by controlling display of a display included in the non-contact display.

16. The control system according to claim 1, wherein the at least one processor is further configured to execute the instructions to:
control a height of the aerial image formation by controlling a height of a table on which the non-contact display is installed.

17. The control system according to claim 1,
wherein the at least one processor is further configured to execute the instructions to:
acquire, for each user, data in which biometric data of the each user and physical data indicating a height of the each user are associated with each other; and
perform biometric authentication of the each user based on biometric data of a current user of the non-contact display and the acquired biometric data;
perform the biometric authentication in a case where the person is a user of the non-contact display, and
perform control to change at least any one of a height, a position, an orientation, and a size of the aerial image formation based on a position of a face of the user according to a height represented by physical data of the authenticated user when the specific screen is displayed.

18. A control method comprising:
detecting a face of a person using a sensor; and
performing control in such a way that when a screen other than a specific screen among a plurality of screens to be displayed on a non-contact display is displayed, an aerial image formation of the non-contact display includes a predetermined height, a predetermined position, a predetermined orientation, and a predetermined size, wherein
the performing control includes performing control to change at least one of a height, a position, an orientation, and a size of the aerial image formation for displaying the specific screen based on a position of the detected face of the person when the specific screen is displayed.

19. A computer-readable tangible recording medium that records a program, the program causing a computer to execute the steps of:
detecting a face of a person using a sensor; and
performing control in such a way that when a screen other than a specific screen among a plurality of screens to be displayed on a non-contact display is displayed, an aerial image formation of the non-contact display includes a predetermined height, a predetermined position, a predetermined orientation, and a predetermined size, wherein
the performing control includes performing control to change at least one of a height, a position, an orientation, and a size of the aerial image formation for displaying the specific screen based on a position of the detected face of the person when the specific screen is displayed.
